(19) United States
(12) Patent Application Publication
(10) Pub. No.: US 2022/0352680 A1
(43) Pub. Date: Nov. 3, 2022

(54) Power Strip Belt Clip

(71) Applicant: Salvatore Naimo, Bayside, NY (US)

(72) Inventor: Salvatore Naimo, Bayside, NY (US)

(21) Appl. No.: 17/732,194

(22) Filed: Apr. 28, 2022

Related U.S. Application Data
(60) Provisional application No. 63/181,470, filed on Apr. 29, 2021.

(51) Int. Cl. H01R 25/00; H01R 13/73

(52) U.S. Cl. CPC H01R 25/006; H01R 13/73

(57) ABSTRACT

An apparatus, relating to a modified version of a power strip, consisting of a power strip fastened to one side of a plastic plate, or any other comparable material, consisting of an extended male cord that can be plugged into a female end of an extension cord, a quick extension cord reel and release mechanism that can house a long extension cord, by which the extension cord can be wound up when length is not needed, or quickly released when more length is needed, and a clip fastened to the other side of the plastic plate, or any other comparable material, that allows the user to attach the power strip with the corded power tool plugged into it, to a tool belt, pocket, or any other convenient location.

### BACKGROUND OF INVENTION

In the construction sector, as well as the home improvement sector, corded power tools are an essential to complete many tasks and jobs. However, it is very common, and almost always a necessity, to connect an extension cord to the corded power tools being used to achieve a greater distance from the power source to the corded power tool. This makes the corded power tool cumbersome and heavier to operate while attached to an extension cord due to the weight of the corded power tool combined with the weight of the extension cord. Many times, there are added risks from extension cords that hang loose from the power source to the power tool, as tripping can occur and accidental yanking of the power tool. This can lead to work interruptions and/or injuries.

According to an article by Raymond Mann (a global fall protection technical service engineer at 3M's personal safety division), The Impact of Falling Tool Incidents, falling objects on a work site is one of the World Steel Association's top-five hazards in almost every industry, including manufacturing, transportation, metalworking, and construction. According to the U.S. Bureau of Labor Statistics, “there are more than 42,400 ‘struck by falling object’ OSHA recordable incidents every year in the United States. It is suggested that “the primary system to prevent tools and equipment from falling is tethering tools and equipment with connectors, connection points, and anchors”. The Power Strip Belt Clip addresses these concerns and can reduce these and other risks.

### SUMMARY OF INVENTION

The Power Strip Belt Clip relates to a modified version of a power strip. The Power Strip Belt Clip, the apparatus, consists of a power strip fastened to one side of a plastic plate, or any other comparable material, and a clip fastened to the other side of the plastic plate. This apparatus allows the user to plug a corded power tool into the power strip, while the clip of the apparatus allows the user to attach the power strip with the corded power tool plugged into it, to a tool belt, pocket, or any other convenient location. The Power Strip Belt Clip also consists of an extended male cord that can be plugged into a female end of an extension cord. The Power Strip Belt Clip backing comes with a clip that can be attached to a tool belt, pocket, beam, etc., and the corded power tool would be plugged into the outlets of the Power Strip Belt Clip. In addition, there is a quick extension cord reel and release mechanism that can house a long extension cord, by which the extension cord can be wound up when length is not needed, or quickly released when more length is needed. This allows the user to wind up and store any extension cord, which can be quickly released to the desired length of the extension cord necessary to complete the job. This feature will provide safety and convenience to the user, eliminating the chance of the corded power tool to be yanked or pulled out of user's hand, while making the corded power tool easier to handle without the excess weight and cumbersome length of a long cord hanging from the corded power tool. The Power Strip Belt Clip can include USB ports to allow the user to conveniently charge mobile devices while completing a job.

This Power Strip Belt Clip allows operating a corded power tool with an extension cord to be safer and more convenient because the extension cord plugged into the wall's outlet and/or power source would not be directly attached to the corded power tool, and would no longer pull on the user's tool, as the corded power tool would be plugged into the power strip attached to the user's belt, pocket, or other convenient location. Another benefit of the Power Strip Belt Clip is that it would make the corded power tool operated by the user much lighter in weight since the weight of the long and heavy extension cord would not be directly attached to the corded power tool, but rather attached to the power strip affixed to the user by way of the clip on the apparatus. The Power Strip Belt Clip also eliminates wear and tear of the corded power tool since there is little stress on the inner parts and cord of the power tool. The Power Strip Belt Clip also allows the user more flexibility and freedom of movement while operating the corded power tool since the user no longer needs to be tethered to the wall to operate the tool, allowing for more work efficiency.

### BRIEF DESCRIPTION OF THE INVENTION

A more complete appreciation of the invention and many more other intended advantages can be readily attained by reference to the following detailed description when considered in connection with the following drawings, wherein:

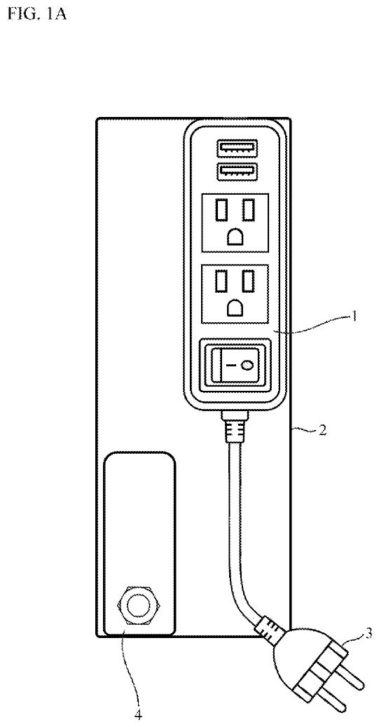

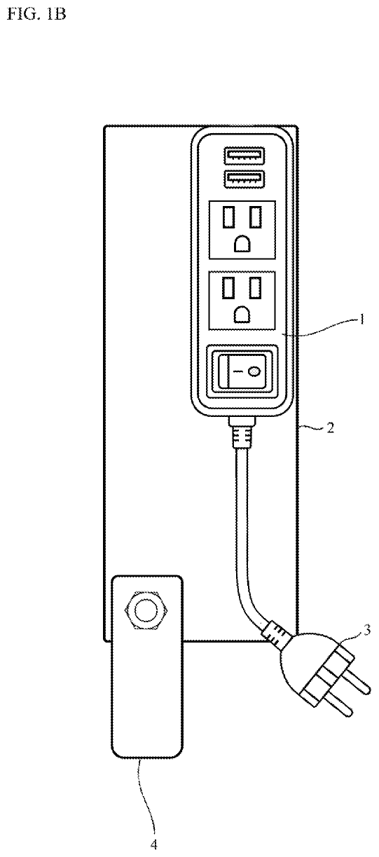

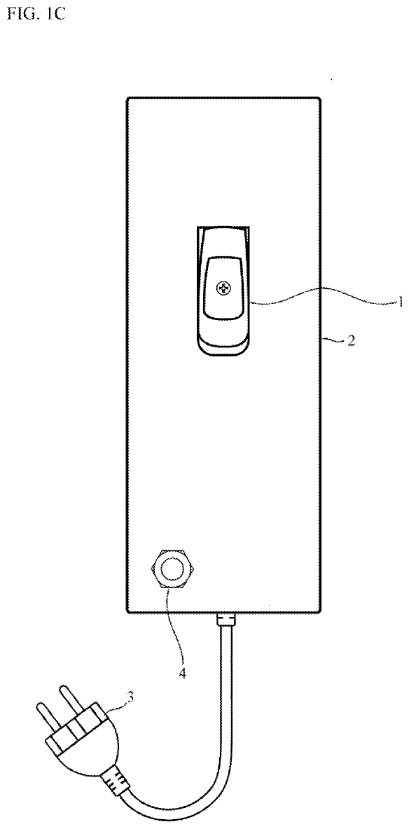

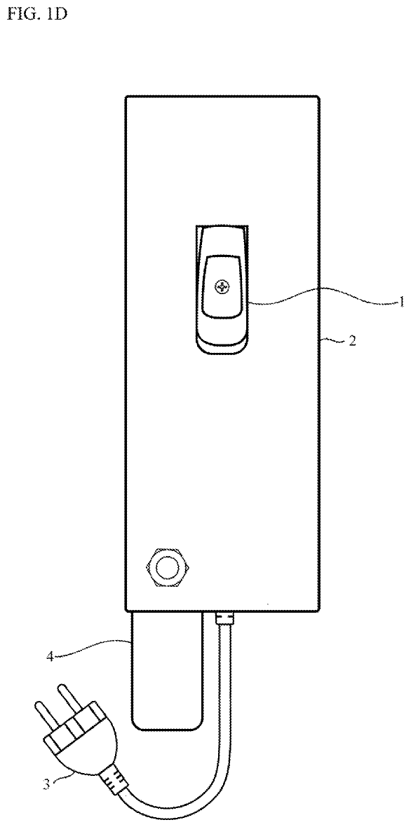

FIG. 1A is a perspective front view illustrating the use of the device of the present invention with the quick extension cord reel and release mechanism in the upward position, for the housing of a long (extension) cord.

FIG. 1B is a perspective front view illustrating the use of the device of the present invention with the quick extension cord reel and release mechanism in the downward position, for the release of a long (extension) cord.

FIG. 1C is a perspective back view illustrating the use of the device of the present invention, demonstrating the clip of the device that can be attached to the user's toolbelt, beam, or any other convenient location, with the quick extension cord reel and release mechanism in the upward position, for the housing of a long (extension) cord (as this is a perspective back view of the device, the quick extension cord reel and release mechanism is not visible in the upward position).

FIG. 1D is a perspective back view illustrating the use of the device of the present invention, demonstrating the clip of the device that can be attached to the user's toolbelt, beam, or any other convenient location, with the quick extension cord reel and release mechanism in the downward position, for the release of a long (extension) cord.

FIG. 1E is a perspective side view illustrating the use of the device of the present invention, demonstrating the clip of the apparatus that can be attached to the user's toolbelt, beam, or any other convenient location, with the quick extension cord reel and release mechanism in the upward position, for the housing of a long (extension) cord, which is depicted here as wrapped around the quick extension cord reel and release mechanism.

FIG. 1F is a perspective back view illustrating the use of the device of the present invention, demonstrating the clip of the apparatus that can be attached to the user's toolbelt, beam, or any other convenient location, with the quick extension cord reel and release mechanism in the downward position, for the release of a long (extension) cord.

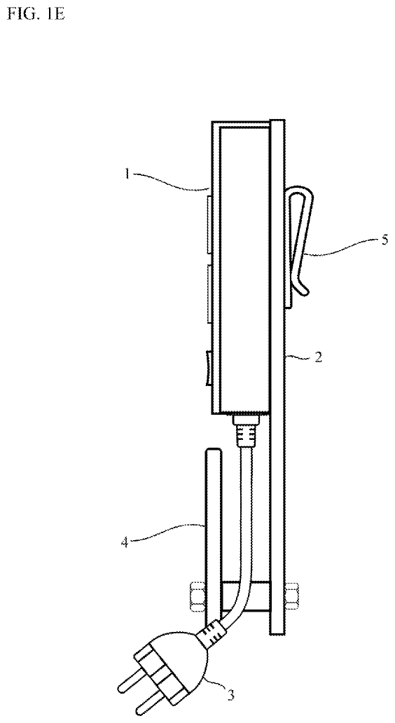

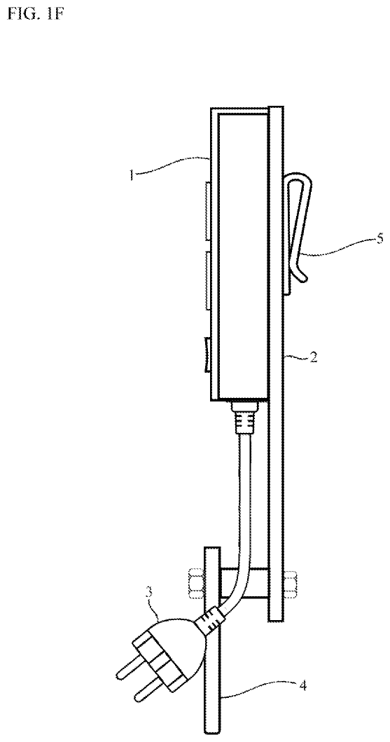

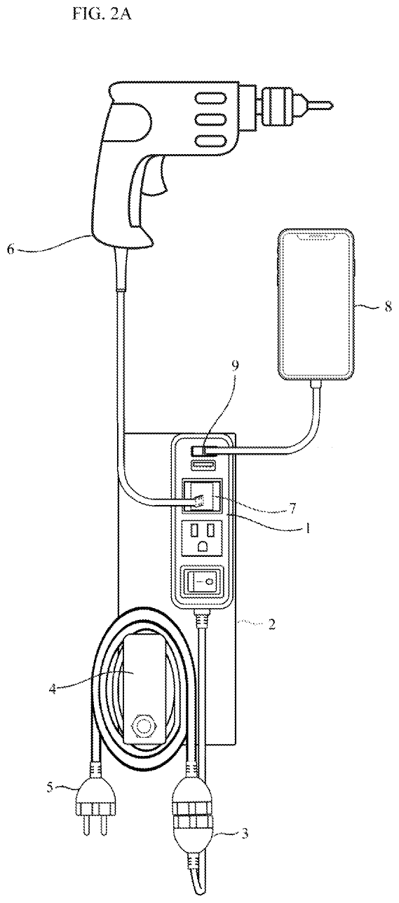

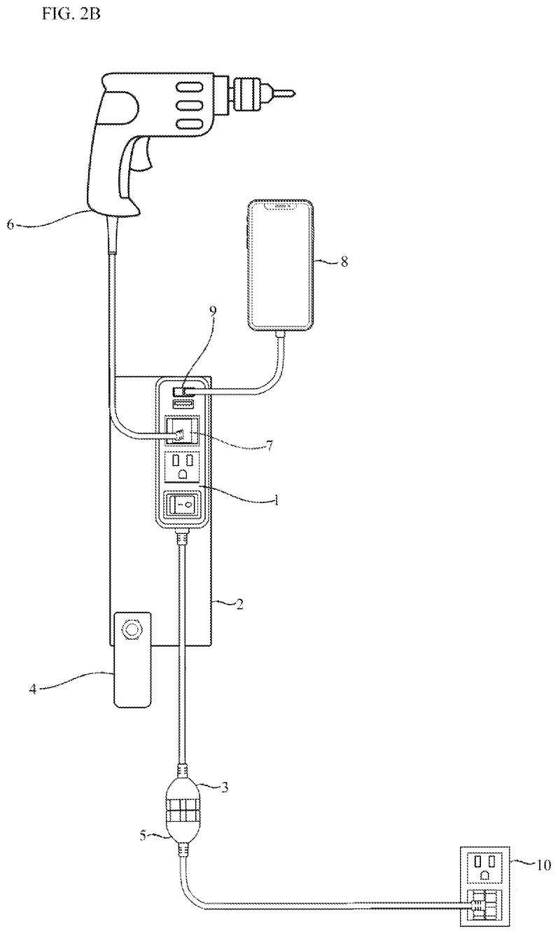

FIG. 2A is a perspective front view illustrating the use of the device of the present invention, demonstrating the use of a power tool plugged into the apparatus, as well as a mobile device plugged into the apparatus, with the quick extension cord reel and release mechanism in the upward position, for the housing of a long (extension) cord, which is depicted here as wrapped around the quick extension cord reel and release mechanism.

FIG. 2B is a perspective front view illustrating the use of the device of the present invention, demonstrating the use of a power tool plugged into the apparatus, as well as a mobile device plugged into the apparatus, with the quick extension cord reel and release mechanism in the downward position, for the release of a long (extension) cord, which is plugged into a wall outlet

### DETAILED DESCRIPTION OF THE PREFERRED EMBODIMENT

The front view of the device of the present invention is shown in FIG. 1A and FIG. 1B as the power strip 1 is fastened to the metal, plastic, or similar material, plate 2 with an extended male cord 3 that can be plugged into a female end of an extension cord, and a quick extension cord reel and release mechanism 4, by which the extension cord can be wound up when length is not needed, or quickly released when more length is needed. As shown in FIG. 1A, the quick extension cord reel and release mechanism 4 is in the upward position to house the extension cord, as a longer length is not needed. As shown in FIG. 1B, the quick extension cord reel and release mechanism is in the downward position, to allow the release of the extension cord as more length is needed.

The back view of the device of the present invention is shown in FIG. 1C and FIG. 1D as the clip of the apparatus 1, which allows the user to attach the power strip with the corded power tool plugged into it, to a tool belt, pocket, or any other convenient location, is fastened to the metal, plastic, or similar material, plate 2 with an extended male cord 3 that can be plugged into a female end of an extension cord, and a quick extension cord reel and release mechanism 4, by which the extension cord can be wound up when length is not needed, or quickly released when more length is needed. As shown in FIG. 1C, the quick extension cord reel and release mechanism 4 is in the upward position to house the extension cord, as a longer length is not needed. As shown in FIG. 1D, the quick extension cord reel and release mechanism is in the downward position, to allow the release of the extension cord as more length is needed.

The side view of the device of the present invention is shown in FIG. 1E and FIG. 1F as the power strip 1 is fastened to the metal, plastic, or similar material, plate 2 with an extended male cord 3 that can be plugged into a female end of an extension cord, and a quick extension cord reel and release mechanism 4, by which the extension cord can be wound up when length is not needed, or quickly released when more length is needed, as the clip of the apparatus 5, which allows the user to attach the power strip with the corded power tool plugged into it, to a tool belt, pocket, or any other convenient location. As shown in FIG. 1E, the quick extension cord reel and release mechanism 4 is in the upward position to house the extension cord, as a longer length is not needed. As shown in FIG. 1F, the quick extension cord reel and release mechanism is in the downward position, to allow the release of the extension cord as more length is needed.

The front view of the device of the present invention is shown in FIG. 2A and FIG. 2B as the power strip 1 is fastened to the metal, plastic, or similar material, plate 2 with an extended male cord 3 that can be plugged into a female end of an extension cord 5, and a quick extension cord reel and release mechanism 4, by which the extension cord can be wound up when length is not needed, or quickly released when more length is needed. A power tool 6 is demonstrated as plugged into the power strip of the apparatus 1 by way of a power cord 7. A mobile device 8 is demonstrated as plugged into the power strip of the apparatus 1 by way of a USB cord 9. As shown in FIG. 2A, the quick extension cord reel and release mechanism 4 is in the upward position to house the extension cord, as a longer length is not needed. As shown in FIG. 2B, the quick extension cord reel and release mechanism is in the downward position, to allow the release of the extension cord as more length is needed, as it is plugged into a wall outlet 10.

What is claimed is an apparatus consisting of:

1. A power strip fastened to one side of a plastic plate, or any other comparable material.

2. An extended male cord that can be plugged into a female end of an extension cord.

3. A quick extension cord reel and release mechanism that can house a long extension cord, by which the extension cord can be wound up when length is not needed, or quickly released when more length is needed.

4. A clip fastened to the other side of the plastic plate, allowing the user to plug a corded power tool into the power strip, while the clip of the apparatus allows the user to attach the power strip with the corded power tool plugged into it, to a tool belt, pocket, or any other convenient location.
DESCRIPTION OF PARTS FOR NUMBERS OF THE POWER STRIP BELT CLIP
1. POWER STRIP
2. PLATE
3. EXTENDED MALE CORD
4. EXTENSION CORD REEL AND RELEASE MECHANISM
5. MOUNTING CLIP
